(19) United States
(12) Patent Application Publication
(10) Pub. No.: US 2007/0149652 A1
(43) Pub. Date: Jun. 28, 2007

(54) Suspension polymerization process

(75) Inventors: Hichang Yoon, Corvallis, OR (US); Tina Barbata, Rochester, NY (US); Lloyd A. Lobo, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/319,335

(22) Filed: Dec. 28, 2005

(51) Int. Cl. C09B 67/00

(52) U.S. Cl. 523/333; 523/339; 430/110.2; 430/137.14

(57) ABSTRACT

The present invention is a method of making polymeric particles having a predetermined and controlled size and size distribution. The method includes dissolving a polymer in a solvent to form a solution wherein the solvent is substantially immiscible with water. A suspension of small droplets of the solution is formed in water containing a water soluble promoter and a stabilizer comprising a surfactant free copolymer by high shear agitation. The stabilizer includes (i) about 55 to about 95 percent by weight, based on total monomer weight, of an addition polymerizable p-tert-butyl styrene and/or (ii) about 5 to about 45 percent by weight, based on total monomer weight, of an addition polymerizable ionic monomer. The solvent is removed from the droplets and the solidified polymer particles are separated from the water. The present invention as provides polymer particles having a core of polymer coated with a layer of smaller particles of a copolymer of the stabilizer described in the method.

### FIELD OF THE INVENTION

This invention relates to a method for the preparation of polymeric powders suitable for use as electrostatographic toner, and more particularly, to a method for the preparation of polymer particles in which surfactant-free linear polymer latex is used to stabilize the particulates.

### BACKGROUND OF THE INVENTION

Polymer particles can be prepared by a process frequently referred to as “evaporative limited coalescence”. In this process, polymer particles having a narrow size distribution are obtained by forming a solution of a polymer in a solvent that is immiscible with water, dispersing the solution so formed in an aqueous medium containing a solid colloidal stabilizer and removing the solvent. The resultant particles are then isolated, washed and dried.

In the practice of this technique, polymer particles are prepared from any type of polymer that is soluble in a solvent that is immiscible with water. Thus, the size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by mechanical shearing using rotor-stator type colloid mills, high pressure homogenizers, agitation etc.

Limited coalescence techniques of this type have been described in numerous patents pertaining to the preparation of electrostatic toner particles because such techniques typically result in the formation of polymer particles having a substantially uniform size distribution. Representative limited coalescence processes employed in toner preparation are described in U.S. Pat. Nos. 4,833,060 and 4,965,131 to Nair et al., incorporated herein by reference for all that they contain.

This technique includes the following steps: mixing a polymer material, a solvent and optionally a colorant and a charge control agent to form an organic phase; dispersing the organic phase in an aqueous phase comprising a particulate stabilizer and homogenizing the mixture; evaporating the solvent and washing and drying the resultant product.

The colloidal stabilizer of choice according to U.S. Pat. No. 4,833,060 uses particulate stabilizer of silica colloid, which requires extensive digestion and washing steps to remove it from the toner surface. In order to eliminate these steps in U.S. Pat. No. 4,965,131, Nair et al. used colloidal solid latex, a copolymer of an additional polymerizable nonionic oleophilic monomer, an addition polymerizable nonionic hydrophilic monomer, an addition polymerizable ionic monomer, and 0 to about 20 percent, by weight, of a crosslinking monomer having at least two addition polymerizable groups. The crosslinking is carried out to make the stabilizing latex more like a particle and behave similar to the colloidal silica. However, when crosslinked latex is used in toner preparation, it increases toner viscosity so that the fusing of toner in the later step of electrophotographic process would be in jeopardy. Also, even if non-crosslinked latex is used, the process requires through washing step to remove surfactant used in the preparation of latex stabilizer.

In a modified version of aforementioned patents, Tavernier et al. disclosed in U.S. Pat. No. 5,620,826 assigned to Agfa-Gevaert, that water-soluble (co)polymer, comprising hydrophobic and hydrophilic moieties, is used as stabilizer to replace silica colloid and is washed away after evaporation of organic solvent. However, it is well known in the skilled art of interest that water soluble polymer or surfactant when used as suspension stabilizer always results in wide particle size distribution. For example, ratio of volume average diameter (Dᵥ) to number average diameter (Dₙ) was 6.8 μm/4 μm (=1.7) measured by Coulter Counter™ as disclosed in the same patent by Tavernier et al., whereas the ratio was 1.30 for the toner stabilized by silica colloid as disclosed in U.S. Pat. No. 4,833,060. Another adverse effect of water-soluble polymer stabilizer is that it has to be completely removed from the toner surface in order to avoid sticking to each other and effect on charge of toners and the powder flow properties.

Therefore, there is a need of new stabilizer that obviates all of these problems described previously herein.

### SUMMARY OF THE INVENTION

The present invention is a method of making polymeric particles having a predetermined and controlled size and size distribution. The method includes dissolving a polymer in a solvent to form a solution wherein the solvent is immiscible or partially miscible with water. A suspension of small droplets of the solution is formed in water containing a water soluble promoter and a stabilizer comprising a surfactant free copolymer by high shear agitation. The stabilizer includes (i) about 55 to about 95 percent by weight, based on total monomer weight, of an addition polymerizable p-tert-butyl styrene and/or (ii) about 5 to about 45 percent by weight, based on total monomer weight, of an addition polymerizable ionic monomer. The solvent is removed from the droplets and the solidified polymer particles are separated from the water. The present invention as provides polymer particles having a core of polymer coated with a layer of smaller particles of a copolymer of the stabilizer described in the method.

### DETAILED DESCRIPTION OF THE INVENTION

In accordance with this invention, a colloidal solid copolymer of certain monomers copolymerized in particular proportions is used as the solid colloidal stabilizer for polymer or polymerizable monomer droplets suspended in an aqueous medium. This copolymer is prepared by emulsion polymerization without stabilizing surfactant. This copolymer limits the coalescence of the droplets to provide polymer particles having a narrow size distribution.

Accordingly, this invention provides a method of preparing polymer particles which comprises forming a suspension of polymer droplets in an aqueous medium and forming a layer of solid colloidal stabilizer on the surface of the droplets to control the size and size distribution of the polymer particles. The stabilizer comprises a copolymer of

(1) about 55 to about 95 percent by weight, based on total monomer weight, of an addition polymerizable p-tert-butyl styrene;

(2) about 5 to about 45 percent by weight, based on total monomer weight, of an addition polymerizable ionic monomer.

There are certain advantages of this invention. This new stabilizer does not increase toner viscosity. Particle size can be controlled with ease while particle size distribution (PSD) is very narrow, comparable to silica colloid stabilizer and much better than water-soluble polymer stabilizer. Also, there is no need of removal of stabilizer from toner surface and washing formed toner particles as extensive as either silica colloid or water-soluble polymer stabilizer.

This invention also provides an electrostatographic toner comprising such copolymer particles.

These and other features and advantages of the present invention will be better understood taken in conjunction with the following detailed description and claims.

The present invention is a modification of the evaporative limited coalescence process described in U.S. Pat. Nos. 4,883,060 and 4,965,131, the disclosures of which is hereby incorporated by reference.

A binder polymer and optionally a colorant and a charge control agent are dissolved in a water-immiscible or partially miscible organic binder solvent to form a binder solution, which is dispersed in water containing a latex stabilizer of present invention to form an aqueous suspension of droplets that is subjected to high shear to reduce droplet size and form limited coalescence particles. The organic solvent is then removed so as to produce a suspension of monodisperse particles of the binder. The water is then removed and the toner composition recovered.

As indicated above, the present invention is applicable to the preparation of polymeric particles from any type of polymer that is capable of being dissolved in a solvent that is immiscible or partially miscible with water and includes copolymers. Useful binder polymers include vinyl polymers, such as homopolymers and copolymers of styrene monomers, and condensation polymers such as polyesters and copolyesters. Particularly useful binder polymers are styrene polymers of from 40 to 100 percent by weight of styrene monomers and from 0 to 45 percent by weight of one or more alkyl acrylate monomers or alkyl methacrylate monomers. Fusible styrene-acrylic copolymers that are covalently lightly cross-linked with a divinyl compound such as divinylbenzene, as disclosed in U.S. Reissue Pat. No. 31,072, are particularly useful. Also especially useful are polyesters of aromatic dicarboxylic acids with one or more aliphatic diols, such as polyesters of isophthalic or terephthalic acid with diols such as ethylene glycol, cyclohexane dimethanol and bisphenols.

Another useful binder polymer composition comprises: a copolymer of (a) at least one vinyl aromatic monomer; (b) at least one second monomer selected from the group consisting of conjugated diene monomers and acrylate monomers selected from the group consisting of alkyl acrylate monomers and alkyl methacrylate monomers.

Yet another useful binder polymer composition comprises:

a) copolymer of a vinyl aromatic monomer; a second monomer selected from the group consisting of conjugated diene monomers or acrylate monomers selected from the group consisting of alkyl acrylate monomers and alkyl methacrylate monomers; and

b) the acid form of an amino acid soap which is the salt of an alkyl sarcosine having an alkyl group which contains from about 10 to about 20 carbon atoms. Binder polymer compositions of this type with a third monomer, which is a crosslinking agent, are described in U.S. Pat. No. 5,968,700. Binder polymer compositions of this type without the crosslinker are made in accordance with the process described in U.S. Pat. No. 5,247,034.

Various additives generally present in electrostatograhic toner may be added to the polymer prior to dissolution in the solvent or in the dissolution step itself, such as colorants, charge control agents, waxes and lubricants.

Colorants, a pigment or dye, suitable for use in the practice of the present invention are disclosed, for example, in U.S. Reissue Pat. No. 31,072 and in U.S. Pat. Nos. 4,160,644; 4,416,965; 4,414,152; and 2,229,513. Colorants are generally employed in the range of from about 1 to about 30 weight percent on a total toner powder weight basis, and preferably in the range of about 2 to about 15 weight percent. Mixtures of colorants can also be used. Colorants in any form such as dry powder, its aqueous dispersions or wet cake can be used in the present invention. Colorant milled by any methods like media-mill or ball-mill can be used too.

The term “charge control” refers to a propensity of a toner addendum to modify the triboelectric charging properties of the resulting toner. A very wide variety of charge control agents for positive charging toners are available. A large, but lesser number of charge control agents for negative charging toners is also available. Suitable charge control agents are disclosed, for example, in U.S. Pat. Nos. 3,893,935; 4,079,014; 4,323,634; 4,394,430 and British Patents 1,501,065; and 1,420,839. Charge control agents are generally employed in small quantities such as, from about 0.1 to about 5 weight percent based upon the weight of the toner. Additional charge control agents which are useful are described in U.S. Pat. Nos. 4,624,907; 4,814,250; 4,840,864; 4,834,920; 4,683,188 and 4,780,553. Mixtures of charge control agents can also be used.

Any suitable solvent that will dissolve the polymer and which is also substantially immiscible with water may be used such as for example, chloromethane, dichloromethane, ethyl acetate, propyl acetate, vinyl chloride, MEK, trichloromethane, carbon tetrachloride, ethylene chloride, trichloroethane, toluene, xylene, cyclohexanone, 2-nitropropane and the like. Particularly useful solvents are ethyl acetate, propyl acetate, and dichloromethane for the reason that they are good solvents for many polymers while at the same time they are substantially immiscible with water. Further, its volatility is such that it is readily removed from the discontinuous phase droplets by evaporation.

The copolymer stabilizers used in this invention are conveniently prepared by conventional aqueous emulsion polymerization processes that is free of surfactant stabilizer, although other methods of preparation known to those skilled in the art may also be feasible. In such an emulsion polymerization process, the various monomers necessary to form the desired copolymer, together with minor amounts of ingredients such as polymerization initiators are added to water. In addition to the monomers, a typical polymerization mixture can include, for example, about 35 to about 97% by weight, water. A water-soluble free radical initiator, typically about 0.1 to about 10%, by weight, (based on total monomer weight), and preferably about 0.5 to about 5%, is used to initiate the polymerization. Examples of suitable initiators include redox systems comprising persulfates such as potassium persulfate or ammonium persulfate and a bisulfite such as sodium bisulfite or potassium bisulfite. Free radical initiators, e.g., azo compounds such as 4,4′-azobis(4-cyanovaleric acid) 2,2′-azobis(2-amidinopropane)hydrochloride or 2,2′-azobis(2-methylpropanesulfonate) and peroxides such as benzoyl peroxide can be used.

The useful copolymer stabilizer in this invention comprises a copolymer of

(1) about 55 to about 98 percent by weight, based on total monomer weight, of an addition polymerizable nonionic oleophilic monomer such as styrene or p-tert-butyl styrene;

(2) about 2 to about 45 percent by weight, based on total monomer weight, of an addition polymerizable ionic monomer such as acrylic acid, methacrylic acid and styrene sulfonic acid or its metallic salt such as sodium and potassium salts.

In a typical emulsion polymerization process, the water is degassed with an inert gas such as argon or nitrogen, to remove oxygen, and a mixture of the monomers is added to the water. The initiator is added and the mixture is heated at about 80° C. to 90° C. for about 1 to 3 hours. The polymerization is complete when the monomer concentration, which can be monitored, diminishes to nearly zero.

The resulting copolymers typically have average diameters (swollen, in water) in the range of about 0.01 to about 1.0 micrometer, often about 0.01 to about 0.3 micrometer. The copolymers are solid colloidal materials that are insoluble but dispersible in water and function as excellent stabilizers for the process of this invention. It is convenient to use them in such processes in the form of aqueous latexes.

The copolymer stabilizers used in this invention perform their function of stabilizing the aqueous suspension of droplets without additional stabilizers. The copolymer stabilizer particles uniformly cover the surface of the suspended droplets forming a layer on the polymer particles formed in the process. The size and concentration of these stabilizers control and predetermine the size of the final toner particles (i.e., the smaller the size and/or the higher the concentration of such particles, the smaller the size of the final toner particles).

The invention will be more fully understood by reference to the following exemplary embodiment, which is set forth solely for purposes of exposition and is not to be construed as limiting.

Stabilizer Preparation

Standard Procedure

Four hundred and seventy-five grams (475 g) of aqueous solution of NaHCO₃ at 0.5 g/L concentration is repeatedly degassed with vacuum and by purging with nitrogen, to remove oxygen. Twenty-five grams (25 g) of the monomer mixture, one gram (1 g) of potassium persulfate and one gram (1 g) of iso-propanol were added to the water and the mixture is heated at 80° for about 2 hours with continuous stirring under nitrogen atmosphere. Particle size was measured by Microtrac™ UPA 150.

Comparative Stabilizer

Mixture of three hundred and eighty grams (380 g) water and 1.5 g sodium dodecyl sulfate (SDS) stabilizer was repeatedly degassed with vacuum and by purging with nitrogen, to remove oxygen. Twenty (20 g) of the monomer mixture, 8 weight percent styrene, 57 weight percent n-butyl methacrylate, 30 weight percent 2-hydroxy ethyl methacrylate and 5 weight percent methacrylic acid, and 0.1 g of ammonium persulfate initiator were added to aqueous media and the mixture is heated at 85° C. for about 2 hours with continuous stirring under nitrogen atmosphere. Particle size distribution measured by UPA was bimodal with peaks at 11 nm and 32 nm. This stabilizer is prepared in accordance with U.S. Pat. No. 4,965,131.

Stabilizer A

Monomer mixture of 85 wt % of p-tert-butyl styrene and 15 weight percent of acrylic acid was used in the preparation of stabilizer A, according to the standard procedure. Particle size by UPA was 161 nm.

Stabilizer B

Monomer mixture of 70 weight percent of p-tert-butyl styrene and 30 wt % of acrylic acid was used in the preparation of stabilizer B, according to the standard procedure. Particle size by UPA was 128 nm.

Stabilizer C

Monomer mixture of 80 weight percent of p-tert-butyl styrene and 20 wt % of sodium styrene sulfonate was used in the preparation of stabilizer C, according to the standard procedure. Particle size by UPA was 87 nm.

Toner Particle Preparation

Standard Procedure

To one hundred grams (100 g) of ethyl acetate was added twenty-five grams (25 g) of Piccotoner™ 1221 binder. This mixture was stirred overnight and comprised the organic phase in the evaporative limited coalescence process. The organic phase was then mixed with an aqueous phase comprising three hundred and seventy-five grams (375 g) of pH 10 buffer containing copolymer stabilizer. This mixture was then subjected to very high shear using a mixer by Silverson, (Model L4R) followed by a homogenizer by Microfluidizer (model 110 F). Upon exiting, the solvent was removed from the formed particles by stirring overnight at room temperature in an open container with nitrogen purge. These particles were filtered, washed with water and dried. The particle size was measured using the COULTER Multisizer II™ instrument with 70 μm aperture.

### COMPARATIVE EXAMPLE

In the standard procedure, 7.5 g of solution comparative stabilizer-copolymer of 8 weight percent styrene, 57 weight percent n-butyl methacrylate, 30 weight percent 2-hydroxy ethyl methacrylate and 5 weight percent methacrylic acid, was used as stabilizer. Number average diameter Dₙ was 3.95 μm whereas volume average diameter Dᵥ showed double peaks at about 4 μm and 10 μm.

### Example 1

In the standard procedure, 10 g of solution stabilizer A, copolymer of 85 weight percent p-tert-butyl styrene and 15 wt % acrylic acid was used as stabilizer. Volume average diameter Dᵥ was 7.38 μm and ratio of volume average diameter to number average diameter, Dᵥ/Dₙ, was 1.28.

### Example 2

In the standard procedure, 10 g of stabilizer B, copolymer of 70 weight percent p-tert-butyl styrene and 30 weight percent acrylic acid was used as stabilizer. Dᵥ was 4.38 μm and Dᵥ/Dₙ was 1.17.

### Example 3

In the standard procedure, 7.5 g of stabilizer B—copolymer of 70 weight percent p-tert-butyl styrene and 30 wt % acrylic acid was used as stabilizer. Dᵥ was 5.91 μm and Dᵥ/Dₙ was 1.11.

Charge measurements were performed on this toner. Four (4) grams of developer was prepared by mixing toner at 8 weight percent concentration with standard carrier of NexPress 2100™ press machine. Carriers employed herein are hard magnetic ferrite carrier particles coated with a polymer such as a silicone resin type polymer or poly(vinylidene fluoride) or preferably poly(methyl methacrylate) or mixtures of poly(vinylidene fluoride) and poly(methyl methacrylate). Fresh developer was tested before exercising. The developer was then exercised for 10 and 60 minutes, respectively, by tumbling in a glass bottle placed in the rotating magnetic field (2,000 rpm) of a magnetic brush developing station before testing the developer. At the end of the 60 minute exercise, half of toner present in the developer was stripped by applying a bias voltage and replaced with fresh toner and rebuilt developer was exercised further for 10 minutes. Results of charge measurements at 40% RH are shown in the table below. In the third column of the table are shown the results with toner that was surface treated with Degussa R972™ silica at 1.5 wt % concentration at 10 minutes with a Waring blender.

Charge/μC/g

| | With surface | With surface |
|---|---|---|
| Developer | treatment | treatment |
| Fresh | −15.9 | −51.5 |
| Exercised for 10 min. | −25.8 | −79.4 |
| Exercised for 60 min. | −32.1 | −78.3 |
| Stripped-Rebuilt for 10 min. | −21.0 | −72.7 |

### Example 4

In the standard procedure, 5 g of stabilizer B, copolymer of 70 weight percent p-tert-butyl styrene and 30 wt % acrylic acid, was used as stabilizer. Dᵥ was 9.13 μm and Dᵥ/Dₙ was 1.10.

### Example 5

In the standard procedure, 7.5 g of stabilizer C copolymer of 80 weight percent p-tert-butyl styrene and 20 wt % sodium styrene sulfonate was used as stabilizer. Dᵥ was 5.06 μm and Dᵥ/Dₙ was 1.40.

### Example 6

In the standard procedure, 5 g of stabilizer C—copolymer of 80 wt % p-tert-butyl styrene and 20 weight percent sodium styrene sulfonate was used as stabilizer. Also, pH of aqueous phase was changed to 7. Dᵥ was 5.41 μm and Dᵥ/Dₙ 1.40. The particle size distribution Examples made with the stabilizers of the present invention, was narrower than the comparative example.

What is claimed:

1. A method of making polymeric particles having a predetermined and controlled size and size distribution which comprises:
preparing an organic phase by dissolving a polymer in a solvent to form a solution, said solvent being substantially immiscible with water;
forming a suspension of small droplets of said organic phase in water containing, optionally, a water soluble promoter and a stabilizer comprising a surfactant free copolymer of (i) about 55 to about 95 percent by weight, based on total monomer weight, of an addition polymerizable p-tert-butyl styrene and (ii) about 5 to about 45 percent by weight, based on total monomer weight, of an addition polymerizable ionic monomer, by high shear agitation; and
removing the solvent from the droplets and separating the resulting polymer particles from the water.

2. The method of claim 1 wherein the promoter is poly(adipic acid-co-methylaminoethanol).

3. The method of claim 1 wherein the organic phase contains coloring agents.

4. The method of claim 1 wherein the organic phase contains magnetic particles.

5. The method of claim 1 wherein the organic phase contains charge control agents.

6. The method of claim 1 wherein the organic phase contains finely dispersed wax particles

7. The method of claim 1 wherein the polymer comprises vinyl polymers copolymers of styrene monomers and polyesters.

8. The method of claim 1 wherein the polymer comprises a copolymer of (a) at least one vinyl aromatic monomer; (b) at least one second monomer selected from the group consisting of conjugated diene monomers and acrylate monomers selected from the group consisting of alkyl acrylate monomers and alkyl methacrylate monomers.

9. The method of claim 1 wherein the polymer comprises a copolymer of a vinyl aromatic monomer; a second monomer selected from the group consisting of conjugated diene monomers or acrylate monomers selected from the group consisting of alkyl acrylate monomers and alkyl methacrylate monomers; and an acid form of an amino acid soap which is the salt of an alkyl sarcosine having an alkyl group which contains from about 10 to about 20 carbon atoms.

10. The method of claim 1 wherein the solvent comprises chloromethane, dichloromethane, ethyl acetate, propyl acetate, vinyl chloride, MEK, trichloromethane, carbon tetrachloride, ethylene chloride, trichloroethane, toluene, xylene, cyclohexanone, and 2-nitropropane.

11. Polymer particles having a core of polymer coated with a layer of a copolymer consisting essentially of:
(i) about 55 to about 95 percent by weight, based on total monomer weight, of an addition polymerizable p-tert-butyl styrene, and
(ii) about 5 to about 45 percent by weight, based on total monomer weight, of an addition polymerizable ionic monomer.
